(19) United States
(12) Patent Application Publication
(10) Pub. No.: US 2025/0238603 A1
(43) Pub. Date: Jul. 24, 2025

(54) Method and System for Enhanced Redaction and Conversion of Spreadsheet Documents in E-Discovery Applications

(71) Applicant: Open Text Technologies, India Private Limited, Hyderabad (IN)

(72) Inventors: Sreedevi Balaji, Secunderabad (IN); Susmitha Puthana, Hyderabad (IN); Arun Kumar Makloor, Hyderabad (IN)

(21) Appl. No.: 18/645,860

(22) Filed: Apr. 25, 2024

(30) Foreign Application Priority Data
Jan. 24, 2024 (IN) 202441004881

(51) Int. Cl. G06F 40/18; G06F 3/04842; G06F 21/62; G06F 40/103

(52) U.S. Cl. CPC G06F 40/18; G06F 21/6209; G06F 40/103; G06F 3/04842

(57) ABSTRACT

The present disclosure pertains to systems and methods for redacting and converting spreadsheet documents within eDiscovery applications. It specifically addresses the challenge of partial cell redaction in spreadsheets and securely embeds these redactions into converted PDF files. A method includes identifying sensitive information, applying redactions using delimiters and regular expressions, and converting the spreadsheet document into an output format, the output format incorporating the redaction in such a way that the redaction is non-reversible. This ensures the permanency of redactions, providing a secure method for handling confidential information in legal proceedings.

### CROSS-REFERENCE TO RELATED APPLICATIONS

This application claims the benefit and priority of Indian patent application Ser. No. 202441004881, filed on Jan. 24, 2024, which is hereby incorporated by reference herein, including all references and appendices cited therein.

### FIELD

The present disclosure relates to methods and systems for redacting and converting electronic documents within e-discovery applications. The present disclosure addresses the challenges of partial cell redaction in spreadsheet formats and the secure, non-reversible embedding of such redactions in converted output files, enhancing confidentiality and compliance in legal document processing.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computer-implemented method for redacting sensitive information within a spreadsheet document. The computer-implemented method also includes receiving a spreadsheet document containing a plurality of cells. The method also includes providing, through a user interface, tools for selecting a text fragment within a selected cell of the spreadsheet document. The method also includes applying a redaction to the selected text fragment within the cell, where remaining content within the selected cell is unaffected by the redaction. The method also includes converting the spreadsheet document into an output format, the output format incorporating the redaction in such a way that the redaction is non-reversible. Other embodiments of this aspect include corresponding computer systems, apparatus, and computer programs recorded on one or more computer storage devices, each configured to perform the actions of the methods.

Implementations may include one or more of the following features. The method where the redaction obscures the selected text fragment while retaining visual markers to indicate a presence of redacted content. The applying further may include: replacing the selected text fragment with delimiters that maintain a structural integrity of the cell; and processing the delimiters when generating the output format, where the delimiters guide application of a visual redaction element. The method may include providing a selection of redaction types, the selection including at least one of: a solid redaction type and a translucent redaction type. The method may include receiving a reason associated with the redaction and embedding the reason into the output format. The output format is a PDF file and the text fragment includes the sensitive information. The redaction is non-reversible, preventing recovery of the redacted sensitive information. The spreadsheet document is native to a spreadsheet software application. The spreadsheet software application lacks a native capability for applying redaction to a text fragment within a cell. The redaction is applied in response to user selection of the text fragment through one of the following user interface actions: highlighting the text fragment; right-clicking the text fragment and selecting a redaction option from a context menu; applying a keyboard shortcut associated with a redaction type. Implementations of the described techniques may include hardware, a method or process, or computer software on a computer-accessible medium.

One general aspect includes a system for redacting sensitive information within a spreadsheet document. The system also includes one or more processors. The system also includes non-transitory computer-readable storage. The system also includes computer-executable instructions stored on the non-transitory computer-readable storage, that when executed by the one or more processors, cause the system to receive a spreadsheet document containing a plurality of cells. The system also includes provide a user interface for selecting a text fragment within a cell of the spreadsheet document. The system also includes apply a redaction to the selected text fragment while maintaining non-redacted content within the same cell. The system also includes generate an output file in a non-reversible format, the output file embedding the redaction. Other embodiments of this aspect include corresponding computer systems, apparatus, and computer programs recorded on one or more computer storage devices, each configured to perform the actions of the methods.

Implementations may include one or more of the following features. The system where the instructions further cause the system to provide a translucent redaction overlay, enabling visibility of the redacted text fragment while indicating presence of redaction. The instructions further cause the system to replace the selected text fragment with delimiters and to process the delimiters during output file generation to guide application of the redaction. The system may include a component that allows the user to select between a solid redaction type and a translucent redaction type. The instructions further cause the system to receive and store a redaction reason indicated by the user, the reason being associated with the embedded redaction in the output file. Implementations of the described techniques may include hardware, a method or process, or computer software on a computer-accessible medium.

One general aspect includes a computer-implemented method for redacting text in a document to generate a redacted PDF. The computer-implemented method also includes opening a document in a processing environment, where the document includes a plurality of text fragments. The method also includes executing a search operation within the document using a regular expression to locate text fragments bounded by delimiters, where the delimiters indicate portions of text within the document to be redacted. The method also includes for each located text fragment, applying a redaction that includes: setting a foreground color of text in the text fragment to a first color if a translucent redaction is specified, or to a second color if a solid redaction is specified; and setting a background color of the text fragment to a third color if a translucent redaction is specified, or to a fourth color if a solid redaction is specified; removing the delimiters from the text fragments within the document; saving the document as a redacted PDF file in a non-editable format where the redacted text fragments are obscured according to the specified redaction type. Other embodiments of this aspect include corresponding computer systems, apparatus, and computer programs recorded on one or more computer storage devices, each configured to perform the actions of the methods.

Implementations may include one or more of the following features. The method where the regular expression used for the search operation includes markers that define a start and end of text fragments to be redacted, with these markers may include metadata that assists in a precise location and redaction application during conversion of the document to a PDF. The method may include the step of receiving input from a user to select the redaction type from a range of available options, where a choice of redaction type influences foreground and background colors applied to the text fragments. A user interface is provided, allowing a reviewer to interact with and alter the redactions applied within the document, and subsequent to such interaction, the method includes the step of updating the document to revise the delimiters and associated metadata to mirror changes made by the reviewer. Implementations of the described techniques may include hardware, a method or process, or computer software on a computer-accessible medium.

### BRIEF DESCRIPTION OF THE DRAWINGS

Exemplary embodiments are illustrated by way of example and not limited by the figures of the accompanying drawings, in which references indicate similar elements.

FIG. 1 illustrates an example computing architecture of a system of the present disclosure.

FIG. 2 is a flowchart that provides a detailed process for managing spreadsheet document redaction within an eDiscovery system.

FIG. 3 is a flowchart presents a step-by-step procedure for handling redactions within an Excel document during the eDiscovery process.

FIG. 4 is a flowchart describes the second part of a redaction process for an eDiscovery application, focusing on the finalization of the redacted document.

FIG. 5 illustrates example code used to manipulate a PDF document generated from an Excel file for the purpose of redacting text.

FIG. 6 illustrates a flowchart of another example method.

FIG. 7 is a flow diagram of an example method.

FIG. 8 is a screenshot of an example redacted document created from an Excel spreadsheet.

FIG. 9 is a diagrammatic representation of an example machine in the form of a computer system.

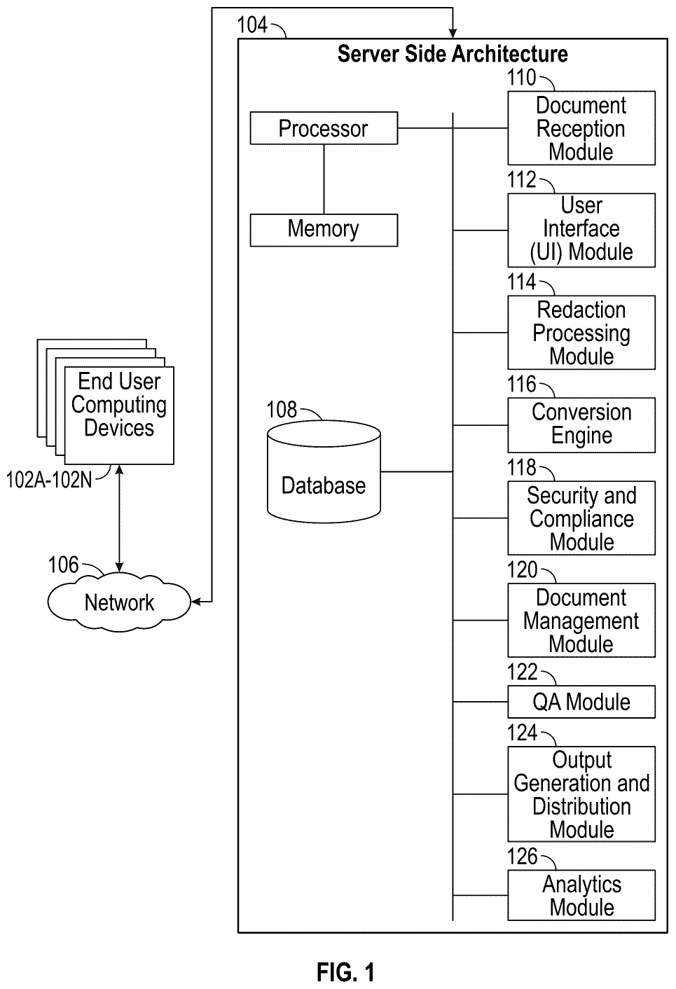

### DETAILED DESCRIPTION OF EXAMPLE EMBODIMENTS

### Overview

There are significant challenges in handling spreadsheet documents (such as Excel) in e-discovery applications due to their inherent complexity, including features like rows, columns, and merged or unmerged cells. Traditional redaction methods, such as overlaying images or markups in PDFs, in certain spreadsheet applications such as Excel, as they do not permanently remove sensitive data and fail to address the unique structural aspects of these documents.

To address these issues, the present disclosure offers a redaction technique specifically designed for spreadsheet documents. An example method allows for precise and secure handling of sensitive data, particularly focusing on partial cell redaction. Furthermore, the present disclosure includes a process for converting redacted Excel documents into PDFs. This conversion ensures that the redactions made in Excel are accurately reflected and preserved in the PDF format, maintaining the document's integrity and security. Unlike conventional methods, this solution guarantees the permanent removal of sensitive information from the document, significantly reducing the risk of unintended data exposure. Additionally, an example method provides customizable redaction options, enabling users to specify reasons for redaction, which is useful in legal and compliance contexts.

The systems and methods disclosed herein are designed for e-discovery applications, providing an advanced solution for handling a range of electronic documents, including chats, emails, PDFs, and, notably, Excel files. In the realm of e-discovery, Excel files present a unique challenge due to their inherent complexity, as noted above. The features significantly complicate the redaction and viewing processes within e-discovery applications. The systems and methods disclosed herein address these challenges by enabling native viewing and redaction of Excel files directly within the e-discovery application, streamlining the process and enhancing efficiency.

One feature of the present disclosure is the ability to burn/produce redactions into PDFs (or other output formats). This process involves converting redacted Excel files into PDF format while maintaining the integrity of the redactions. In standard practice, Microsoft Excel only allows the redaction styles to be applied on whole cell content and not partially, but the present disclosure introduces a method that effectively manages redactions in Excel, specifically overcoming this limitation. One of the most notable capabilities is the partial cell redaction, a function not typically available in Excel. This allows for more detailed and precise control over the redaction process, enhancing the flexibility and utility of the system in sensitive data handling.

Additionally, the systems and methods incorporate a translucent feature for redactions. This is particularly beneficial during quality control reviews, as it enables reviewers to see the context surrounding the redactions, ensuring more accurate and thorough verification. An example system also provides the ability to apply reasons for redactions, like marking them as “confidential” or “sensitive.” These reasons can be included as stamps on the redacted document, adding an extra layer of information and security.

Some embodiments involve identifying cell fragments for redaction, applying delimiters to these fragments, and then appropriately processing them in both the Excel document and the subsequent PDF output. This ensures that redactions are applied accurately and consistently across different formats. The security and permanence of redactions are one advantageous feature. It guarantees that once information is redacted, it is permanently removed and unrecoverable, a feature for maintaining confidentiality and compliance with legal requirements. In some embodiments, the cell fragments include content including, but not limited to, text, imagery, audio content, and/or audio-visual content.

The systems and methods also include custom code for generating PDFs. This code specifically identifies content fragments in PDF pages and applies background and foreground colors during the PDF generation process. This ensures that the redactions are visually represented as intended, maintaining the clarity and readability of the document. The systems and methods leverage a unique approach to handling redactions, particularly in the context of partial cell redactions and its integration into e-discovery applications. This differentiation underscores the present disclosure's approach to addressing the specific challenges in the field of electronic document management and legal compliance.

The integration of partial cell redaction capabilities in Excel to PDF conversions offers a balance between data privacy and visibility, catering to the nuanced needs of users across various domains. This feature enables the selective obscuring of specific characters or digits within a cell, thereby allowing the retention of critical data for analysis or reporting purposes while ensuring sensitive information is shielded. Such a granular approach to redaction aligns with compliance requirements of stringent privacy regulations like GDPR and HIPAA, particularly in financial data management, by enabling the redaction of only the necessary data portions. This method preserves the document's integrity, ensuring the structural layout remains intact and unaltered despite the redaction of sensitive details. Furthermore, it facilitates secure collaboration and sharing of financial reports among stakeholders, providing confidence that confidential information remains protected. Through partial cell redaction, users achieve a meticulous level of control over their data privacy without compromising the document's utility and compliance requisites.

### Example Embodiments

As noted above, the systems and methods of the present disclosure can permanently redact portions, such as a cell, of a spreadsheet document. In more detail, an architecture for implementing the present disclosure could include client-side computing devices for end users 102A-102N, a server-side architecture 104 that could be cloud-based or localized, and a network 106 providing communicative coupling therebetween. The network 106 could include any public or private network. The architecture could include a database 108 for storing original and redacted documents, as well as any intermediate data. This storage can be local (on client devices or on-premises servers) or cloud-based, depending on the system design and data security requirements. The architecture could also include a security infrastructure, which includes appropriate security software and protocols to protect sensitive data during the redaction process and in storage, such as encryption tools, firewalls, and secure data transmission methods. Peripheral devices can also be optionally included such as printers or other output devices, if physical copies of the redacted documents are required.

In general, the server-side architecture 104 implements an e-discovery platform. This e-discovery platform is enhanced with an ability to allow users to indicate portions of a spreadsheet to redact and provide a generated document that provides a version of that spreadsheet as output that can partially or entirely redact the portions identified by the user. The following description is an example arrangement of modules and is provided for descriptive purposes only. Other server-side architectures are contemplated and the features of the various modules can be aggregated or divided as needed.

The server-side architecture 104 can include a document reception module 110 that handles the initial receipt of spreadsheet documents uploaded by users. This module is responsible for validating document formats, ensuring security during upload, and preparing the document for further processing.

The server-side architecture 104 can also include a User Interface (UI) module 112 that provides tools and interfaces for users to interact with the system. This includes functionalities for selecting specific content fragments, such as text fragments, within spreadsheet cells for redaction, applying redaction types, and specifying reasons for redactions. The UI module is used for ensuring a user-friendly experience that allows for precise control over the redaction process.

The server-side architecture 104 can also include a redaction processing module 114 that applies the redactions to selected text fragments within the spreadsheet document. This module implements the logic for obscuring the selected text fragments while retaining the structural integrity of the cell and the document. It handles different redaction types (e.g., solid, translucent) and embeds reasons for redaction, if provided.

The server-side architecture 104 can include a conversion engine 116 that converts the redacted spreadsheet document into a non-reversible output format (in some instances, the underlying text can be selected and deleted as described below using delimiters or bounding boxes), ensuring that redactions are securely embedded within the document. This module is configured to maintain the fidelity of redactions when transitioning from spreadsheet formats like Excel to PDF. The server-side architecture 104 can also include a security and compliance module 118 that ensures that all operations performed on the documents adhere to security standards and compliance requirements. This includes encryption of sensitive data during transmission and storage, as well as maintaining audit logs for tracking actions performed on the documents.

The server-side architecture 104 can include a document management module 120 that manages the storage, retrieval, and sharing of original, redacted, and converted documents. This includes interfacing with database systems (108) or cloud storage solutions to securely store documents and providing access controls to manage who can view or edit the documents. A quality assurance and review module 122 provides functionalities for reviewing redacted documents before final conversion. This may include tools for visual inspection of redactions, making adjustments to redactions, and validating that all sensitive information has been appropriately obscured.

In some instances, an output generation and distribution module 124 handles the generation of the final redacted and converted documents (e.g., PDF files) and facilitates their distribution to authorized users or systems. This includes options for downloading the documents or integrating with email systems for direct distribution. An analytics and reporting module 126 generates reports and analytics on the redaction and conversion processes, including metrics on the volume of documents processed, types of redactions applied, and user activity. This information can be valuable for administrative and compliance monitoring.

Once an Excel document is uploaded by the user, the server-side architecture 104 receives and initiates processing. It analyzes the document's structure, which can include rows, columns, and merged cells, to prepare it for redaction. The server-side architecture 104 then implements the redaction process based on user instructions, applying specific redactions to designated parts of the document, such as certain cells or parts within cells. As noted, the server-side architecture 104 is designed to handle unique challenges like partial cell redaction, replacing redacted content with labels like “confidential.”

In some instances, the redactions are provided by a user through an interface in the e-discovery platform. That is, the server-side architecture 104 can provide a user interface (UI) that allows users to open and view the Excel document. This UI enables users to navigate the document and visually identify data requiring redaction. Users manually select document parts to be redacted, possibly by highlighting text in cells, choosing entire cells, rows, columns, or specific document sections. For finer redactions like partial cell redaction, the server-side architecture 104 could enable users to highlight only certain text parts within a cell.

After data selection, users could be asked to input additional redaction parameters. This step could involve specifying the redaction type, such as blackout or translucent overlay, and the redaction reason, like “confidential” or “personal information.” These inputs help the server-side architecture 104 apply the appropriate redaction technique and create an audit trail. Once the selections and parameters are entered, users confirm their redaction choices, and the server-side architecture 104 processes these inputs to apply the redactions as specified.

Following the initial redaction, the server-side architecture 104 can provide an option for users to review the redacted document. If necessary, a user can alter their selections or parameters and reprocess the document. This review phase ensures the final document meets the specific requirements of the user's context, whether for legal, compliance, or other sensitive purposes. Server-side architecture 104 automation of technical redaction aspects, based on user inputs, ensures both accuracy and efficiency. In more detail, once the areas for redaction are pinpointed, the server-side architecture 104 applies the chosen redaction method. This includes techniques like blacking out text, completely removing it, or applying translucent overlays for preliminary review. The server-side architecture 104 capability to handle partial redactions within a cell is particularly noteworthy. It uses algorithms that precisely target and modify only the selected portions of text, ensuring the rest of the cell's content remains unaffected.

Another feature of this server-side architecture 104 is its use of delimiters in the redaction process. For partial cell redactions, the server-side architecture 104 replaces the redacted text with delimiters, marking the beginning and end of the redacted area. This approach is used to maintain the integrity of the document's structure, especially when translating the redaction from Excel to PDF format.

In the final step, the server-side architecture 104 converts the redacted spreadsheet document into a PDF. This conversion process is carefully engineered to ensure that all redactions, including those involving partial cells, are accurately represented in the PDF. The server-side architecture 104 employs custom code for this conversion, handling the transition of redactions from the Excel environment to the PDF accurately. This ensures that the redactions in the PDF reflect the original intent and specificity of the redactions applied in the Excel document, a critical factor in the context of e-discovery where precision and accuracy of information are paramount.

Following the redaction, the server-side architecture 104 converts the Excel document into a PDF format. This conversion is carefully handled to ensure that all redactions are accurately reflected in the PDF, maintaining the integrity and layout of the original document. The server-side architecture 104 is equipped to process various types of redactions, including standard blackouts and translucent redactions for preliminary reviews.

In some instances, the server-side architecture 104 burns in the redactions. “Burn” can be understood as the act of permanently applying redactions to a document. When a document, especially an Excel file, is “burned,” any redacted information is permanently removed or obscured, ensuring that it cannot be recovered or viewed after the process is complete. This is different from simply overlaying a visual element that can be removed to reveal the underlying text.

To ensure quality, the server-side architecture 104 performs automatic checks on the redacted documents. This is in line with the emphasis on accuracy and compliance with legal standards, especially relevant in e-discovery contexts. Once the redaction and conversion process are complete, the server-side architecture 104 prepares the final redacted PDF for user access. This can involve making the document available for download or storing it in a secure, user-specific area, as indicated by the discussion about document management and secure sharing.

Throughout this process, the server-side architecture 104 maintains detailed audit logs to track each action performed on the document, ensuring compliance with data protection and privacy laws. This aligns with the need for legal compliance and accuracy in handling sensitive information in e-discovery scenarios.

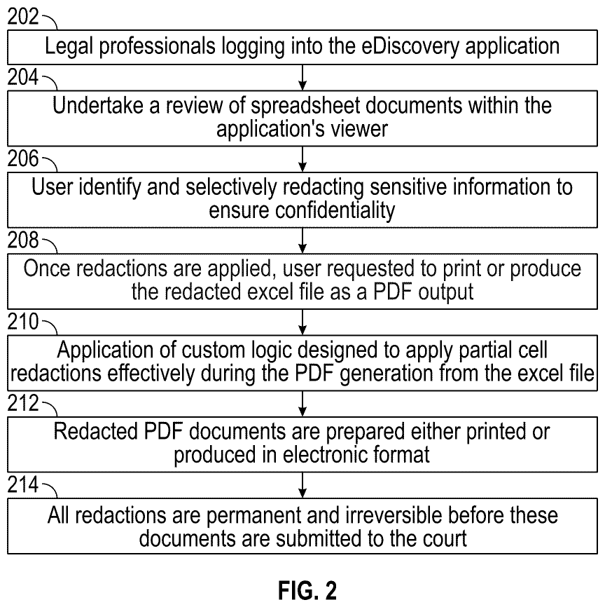

FIG. 2 is a flowchart that provides a detailed process for managing spreadsheet document redaction within an eDiscovery system. It starts with legal professionals logging into the eDiscovery application in step 202, which is the initial access to the document management system. Post-login, the user undertakes a review of documents within the application's viewer in step 204, carefully reviewing and selectively redacting sensitive information to ensure confidentiality. As noted above, a limitation in Microsoft Excel prevents redaction styles being partially applied to cells, which poses a challenge in safeguarding only specific parts of the content.

In some instances, the user can identify and apply a redaction to the selected text fragment within the cell, wherein remaining content within the selected cell is unaffected by the redaction. Once redactions are applied, user requested to print or produce the redacted Excel file as a PDF output.

To overcome this, the workflow integrates custom logic designed to apply partial cell redactions effectively during the PDF generation from the Excel file in step 206. This approach ensures sensitive data is securely obscured while maintaining the visibility of non-sensitive information. Finally, the redacted PDF documents are prepared—either printed or produced in electronic format in step 208—ensuring that all redactions are permanent and irreversible before these documents are submitted to the court in step 210, thus upholding the integrity and confidentiality required in legal proceedings.

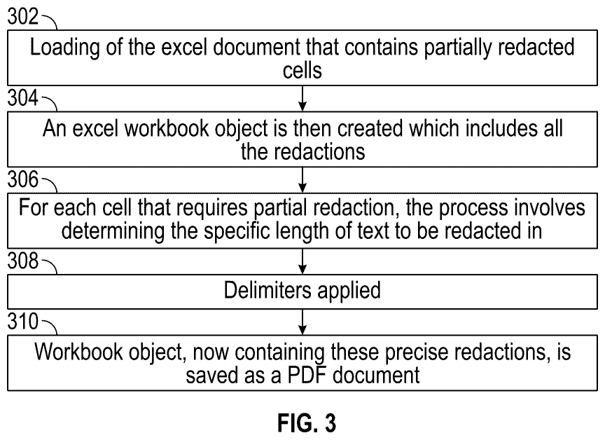

FIG. 3 is a flowchart presents a step-by-step procedure for handling redactions within an Excel document during the eDiscovery process. The method begins at 302 with the loading of the Excel document that contains partially redacted cells into the system. An Excel workbook object is then created in step 304 which includes all the redactions. For each cell that requires partial redaction, the process involves determining the specific length of text to be redacted in step 306. Delimiters are applied in step 308 before and after the identified text to demarcate the redacted areas clearly. Finally, the workbook object, now containing these precise redactions, is saved as a PDF document in step 310, ensuring that the redactions are securely in place and the document is ready for use in legal proceedings.

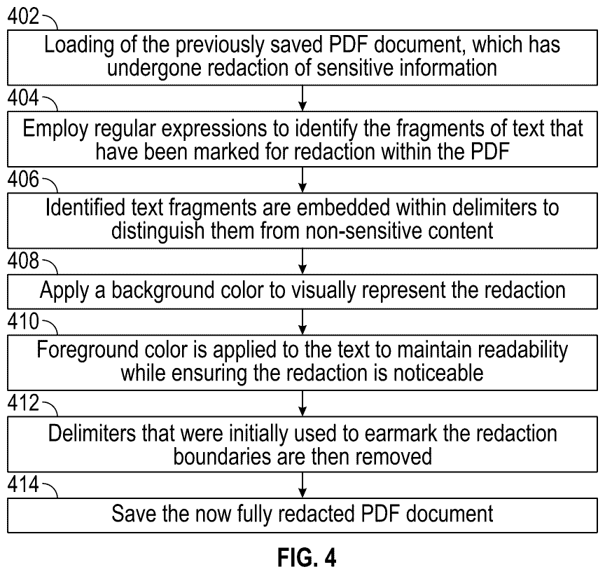

FIG. 4 is a flowchart describes the second part of a redaction process for an eDiscovery application, focusing on the finalization of the redacted document. This flow includes a search for the delimiters and apply background and foreground color when generating PDF.

The flow commences with the loading of the previously saved PDF document, which has undergone redaction of sensitive information in step 402. Next, the system employs regular expressions in step 404 to identify the fragments of text that have been marked for redaction within the PDF. These identified text fragments are embedded within delimiters to distinguish them from non-sensitive content in 406.

Following the identification of redacted text, the system applies a background color to visually represent the redaction in step 408. Additionally, a foreground color is applied to the text in step 410 to maintain readability while ensuring the redaction is noticeable. This dual application of color coding effectively highlights the redacted areas, ensuring that they are clearly discernible from the rest of the document content.

The delimiters that were initially used to earmark the redaction boundaries are then removed in step 412, which cleans up the visual presentation of the document. This step ensures that the final document appears professional and is suitable for its intended purpose within legal proceedings.

The final step in the process is to save the now fully redacted PDF document in 414. This version of the document is ready for printing or burning, which implies that the redactions are permanently affixed and the sensitive information is securely obscured. Once this phase is complete, the document is in its final form, ensuring that any confidential or sensitive information remains protected when the document is printed and presented, such as in a court of law.

### Example Code

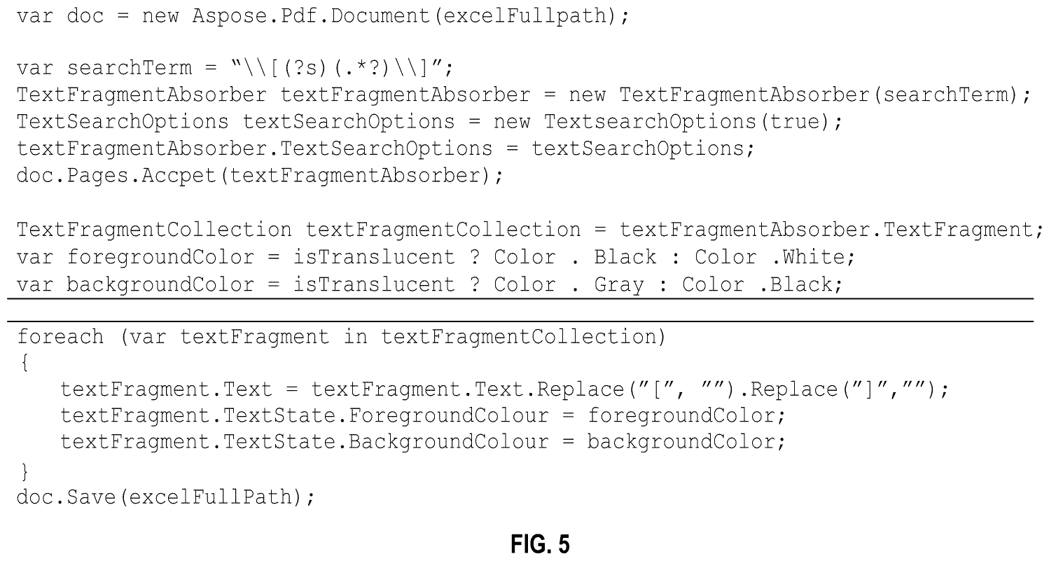

The code in FIG. 5 is used to manipulate a PDF document generated from an Excel file for the purpose of redacting text. The code begins by creating a new document object from a specified file path. The code then defines a search term using a regular expression pattern, which is designed to locate the text fragments within the PDF that are delimited for redaction.

A ‘TextFragmentAbsorber’ object is instantiated using the search term, and it is configured to search across the document with certain options that likely include case sensitivity settings. The document's pages are then processed by the ‘TextFragmentAbsorber’, which collects all instances of text that match the search pattern.

For each text fragment identified, the code applies a foreground color and a background color. The foreground color is conditional upon a flag denoted as ‘isTranslucent’, which determines if the text should be black (likely for solid redaction) or white (for translucent redaction). Similarly, the background color is set to either gray (for translucent redaction) or black (for solid redaction), based on the same flag.

The text of each fragment is then updated to remove the delimiters that were initially used to mark the text for redaction. This cleaning step ensures that the final document does not contain any artifacts from the redaction process. Finally, the modified document is saved back to the original file path, completing the redaction process and finalizing the PDF for printing or burning, which means that the redactions are made permanent and the sensitive information is secured.

In a digital environment, a computing process is initiated to handle the redaction of sensitive information within a document. This document, often originating from a spreadsheet, contains numerous text fragments, each potentially holding information that may require concealment or emphasis.

Upon opening the document within a specialized processing application, a search operation is executed. Employing a finely-tuned regular expression, the software methodically scans through the document. It seeks out specific text fragments marked by predefined delimiters, indicators that certain text within the myriad of words and numbers is slated for redaction.

For each fragment identified in this meticulous search, the computing process applies redaction with precision. It adjusts the visual properties of the text based on the redaction's nature: if the redaction is to be translucent, allowing for underlying text to be faintly visible, the text's foreground is painted in a stark white while its background adopts a subtle gray. Conversely, for a solid redaction, which permits no visibility, the text is ensconced in an opaque black, ensuring complete obfuscation.

Following the application of these redaction parameters, the process enters a phase of refinement. The delimiters, having served their purpose in guiding the redaction, are now stripped away, leaving behind a clean view of the remaining text. This step is used to ensure that the final document appears untampered and professional, devoid of any residual markers or indications of alteration.

The culmination of this procedure is the preservation of the now-redacted document into a PDF format, which is permanent record where redactions are irrevocably embedded. The text that was once visible is now obscured, and the document, in its entirety, is transformed into a non-editable form. This ensures the sanctity of sensitive information, allowing the redacted PDF to be used in various scenarios, including legal proceedings, with confidence that the redacted content remains inaccessible and protected.

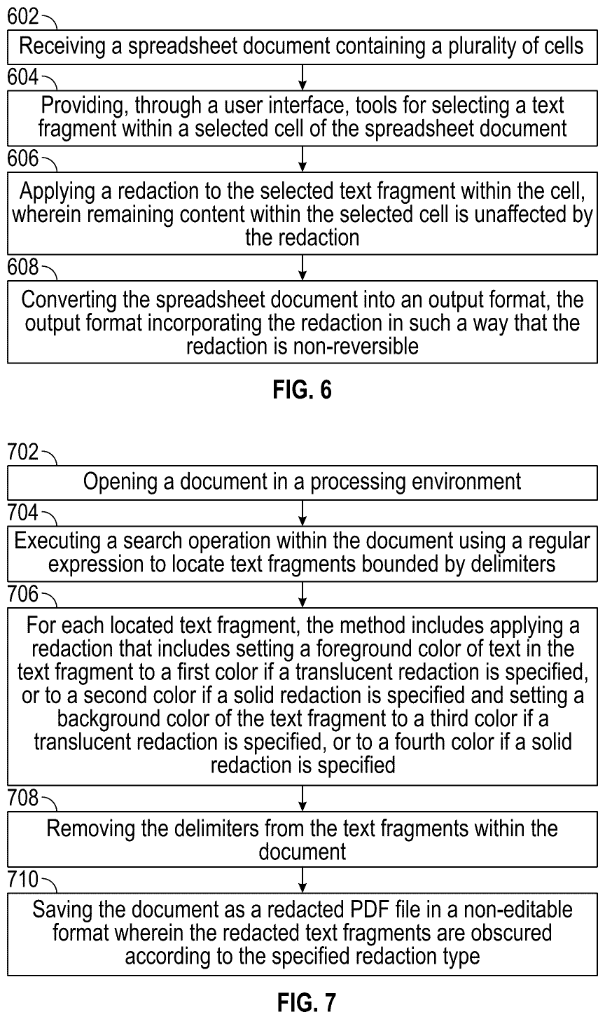

FIG. 6 illustrates a flowchart of another example method. The method includes a step 602 of receiving a spreadsheet document containing a plurality of cells, as well as a step 604 of providing, through a user interface, tools for selecting a text fragment within a selected cell of the spreadsheet document. The method also includes a step 606 of applying a redaction to the selected text fragment within the cell, wherein remaining content within the selected cell is unaffected by the redaction. The method can include a step 608 of converting the spreadsheet document into an output format, the output format incorporating the redaction in such a way that the redaction is non-reversible.

FIG. 7 is a flow diagram of an example method. The method includes a step 702 of opening a document in a processing environment. To be sure, the document includes a plurality of text fragments. The method can include as step 704 of executing a search operation within the document using a regular expression to locate text fragments bounded by delimiters. In some instances, the delimiters indicate portions of text within the document to be redacted.

In step 706, for each located text fragment, the method includes applying a redaction that includes setting a foreground color of text in the text fragment to a first color if a translucent redaction is specified, or to a second color if a solid redaction is specified and setting a background color of the text fragment to a third color if a translucent redaction is specified, or to a fourth color if a solid redaction is specified.

In some embodiments, the method includes a step 708 of removing the delimiters from the text fragments within the document, as well as a step 710 of saving the document as a redacted PDF file in a non-editable format wherein the redacted text fragments are obscured according to the specified redaction type.

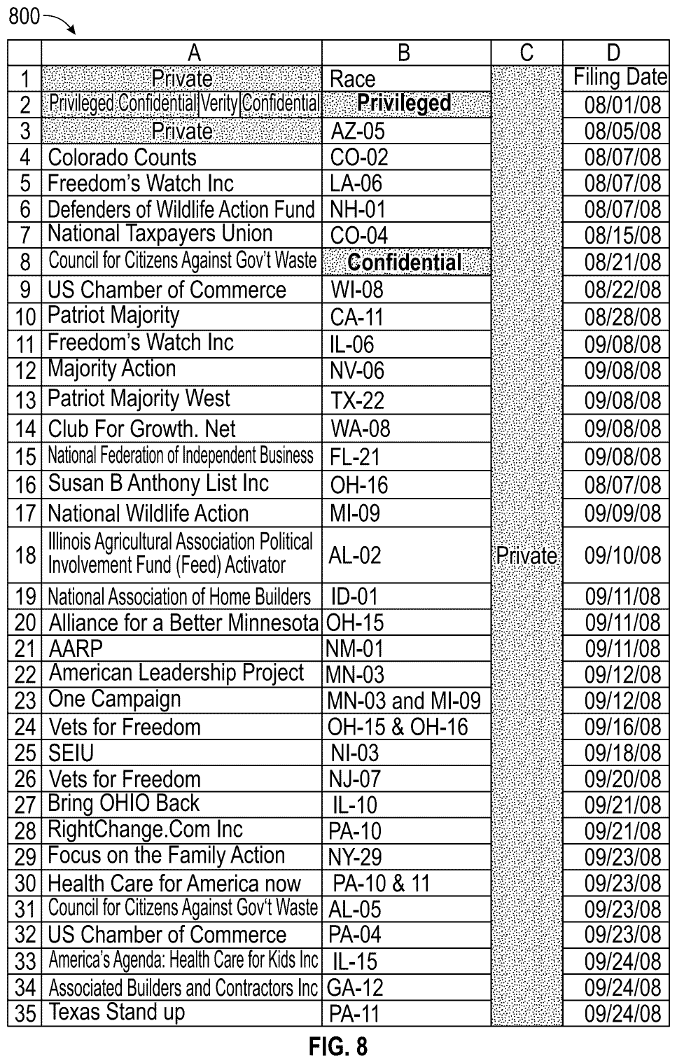

FIG. 8 is a screenshot of an example redacted document 800 created from an Excel spreadsheet. When a spreadsheet undergoes redaction in its native viewer, the process mirrors how a user would typically redact information directly within Excel before converting the document into a PDF format. This method, known as solid redaction, ensures that the final PDF retains the integrity and layout of the original Excel document, albeit with specific data obscured or removed to protect sensitive information. Essentially, the PDF generated from this process presents a document that closely aligns with the user's redaction activities in Excel, providing a seamless transition from the editable spreadsheet to the fixed-format PDF, all while safeguarding the confidentiality of redacted content.

FIG. 8 displays a spreadsheet document with multiple columns and rows, containing a list of organizations or entities along with associated details. The document includes at least four visible columns labeled ‘A’, ‘B’, ‘C’, and ‘D’ with corresponding headers partially redacted.

In column ‘A’, is redacted with the words “PRIVILEGED”, “CONFIDENTIAL”, and “PRIVATE” visible, indicating that redacted parts are related to sensitive classifications. The redaction style used is ‘solid’, completely obscuring the underlying text and indicating that the information is protected or sensitive. Column ‘B’ is partially visible, with the word “PRIVILEGED” clearly redacted, relating to a category or status that requires restricted access. Column ‘C’ is entirely redacted as PRIVATE.

The first column (Column ‘A’) lists various entities or organizations with names like “Colorado Counts”, “Freedom's Watch Inc.”, “Defenders of Wildlife Action Fund”, “National Taxpayers Union”, “Council for Citizens Against Gov't Waste”, and “US Chamber of Commerce”, among others. The second column (Column ‘B’) lists race or district codes corresponding to each entity, such as “AZ-05”, “CO-02”, “LA-06”, “NH-01”, with varying state codes and district numbers. Lastly, the third column (Column ‘C’), as mentioned, contains filing dates that are not redacted and provide a chronological context to the entries.

Overall, the document that has undergone a redaction process to mask sensitive information while leaving other data visible for reference. This type of redaction is often used in legal, compliance, and data privacy contexts to protect confidential information while still providing enough data for analysis or record-keeping. The spreadsheet format and the presence of redactions suggest this document could be related to legal proceedings, compliance audits, and so forth.

Further to the above, in some embodiments, the method comprises defining a bounding box associated with the selected text fragment. This process can be used to permanently remove redacted elements. The bounding box includes a start character of the selected text fragment and an end character of the selected text fragment. Here, the bounding box is processed when generating the output format to generate a redaction element in the output format based on the start character and the end character. In a nonlimiting example, a cell includes 100 characters. A selected text fragment of the cell for redaction starts at character 10 and ends at character 20, defining the bounding box for the selected text fragment from character 10 through character 20. When generating the output format and redaction element in the output format, the bounding box is processed to delete and replace character 10 through character 20 with an equivalent portion to be portrayed by the redaction element in the output format. In this way, the original partial cell redaction is converted to an equivalent redacted portion (that is highly representative of the original redaction) in the output format that is non-reversible.

In a further embodiment, more than one selected text fragment is redacted in the output format. For example, a cell may include two redacted portions and/or a first cell may include a redacted portion, and a second cell may include a redacted portion, and so on. Here, when generating the output format, each redacted portion is processed to produce an equivalent reduction portion in the output format.

### Additional Example Use Cases

The concept of partial redaction, particularly within the context of converting Excel documents to PDF, opens up a range of use cases beyond the realm of eDiscovery, extending its applicability to areas such as HR reports containing employee Personally Identifiable Information (PII), sensitive project plans, financial statements for external auditors, client billing information, and board meeting minutes. This approach allows for the secure sharing of information while ensuring compliance with data protection regulations, such as GDPR and HIPAA, by concealing specific columns or cells containing sensitive data.

For HR reports, redaction enables the secure sharing of documents containing employee PII by masking columns with sensitive information like Social Security Numbers, thus mitigating the risk of data exposure. In the realm of sensitive project plans, it allows for the hiding of specific cells or formulas that contain proprietary information or financial projections, facilitating collaboration without compromising confidential business strategies. For financial statements shared with external auditors, redaction ensures that internal financial figures or sensitive business projections are obscured, allowing for necessary scrutiny while maintaining the confidentiality of strategic financial decisions.

Furthermore, when providing clients with PDF invoices, redaction can be used to conceal specific line items or details not intended for client disclosure, thus enabling transparent billing practices without revealing sensitive financial data or internal cost breakdowns. Lastly, for board meeting minutes that may include sensitive discussions or executive compensation details, redaction ensures that specific sections are hidden before converting them to PDF, thereby supporting transparent communication with board members while preserving the confidentiality of sensitive discussions.

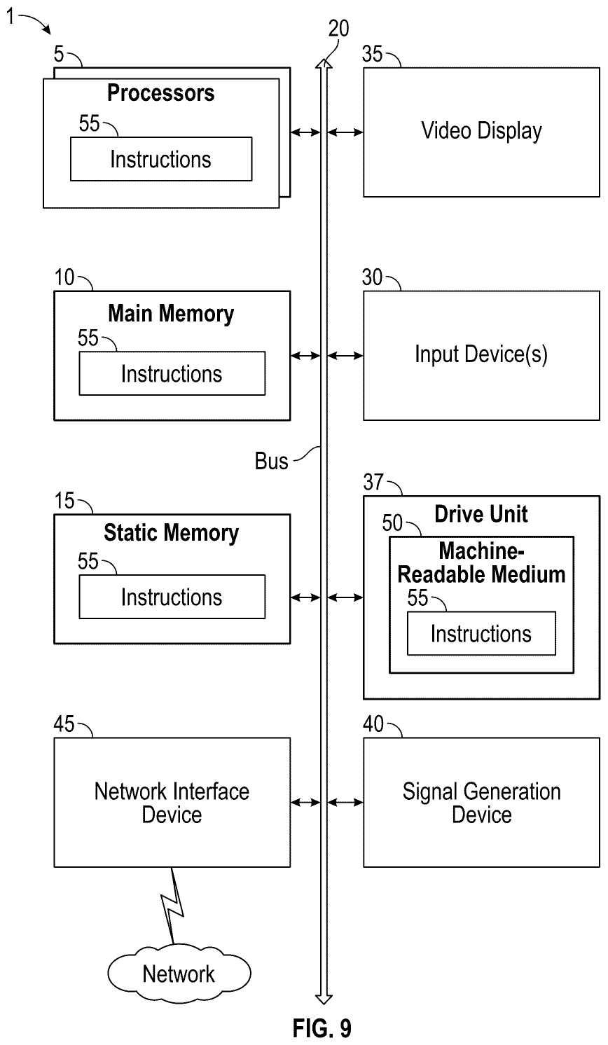

FIG. 9 is a diagrammatic representation of an example machine in the form of a computer system 1, within which a set of instructions for causing the machine to perform any one or more of the methodologies discussed herein may be executed. The system can be used to control any one or more of the components disclosed above.

In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Where appropriate, the functions described herein can be performed in one or more of hardware, software, firmware, digital components, or analog components. For example, the encoding and or decoding systems can be embodied as one or more application specific integrated circuits (ASICs) or microcontrollers that can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In this description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

What is claimed is:

1. A computer-implemented method for redacting sensitive information within a spreadsheet document, the method comprising:
receiving a spreadsheet document containing a plurality of cells;
providing, through a user interface, tools for selecting a text fragment within a selected cell of the spreadsheet document;
applying a redaction to the selected text fragment within the cell, wherein remaining content within the selected cell is unaffected by the redaction; and
converting the spreadsheet document into an output format, the output format incorporating the redaction in such a way that the redaction is non-reversible.

2. The method of claim 1, wherein the redaction obscures the selected text fragment used to be while retaining a visual marker to indicate a presence of redacted content.

3. The method of claim 2, wherein the applying further comprises:
replacing the selected text fragment with delimiters that maintain a structural integrity of the cell; and
processing the delimiters when generating the output format, wherein the delimiters guide application of a visual redaction element.

4. The method of claim 1, further comprising:
defining a bounding box associated with the selected text fragment, the bounding box including a start character of the bounding box and an end character of the bounding box; and
processing the bounding box when generating the output format, including generating a redaction element in the output format based on the start character and the end character.

5. The method of claim 4, wherein the selected text fragment is a plurality of selected text fragments each having an associated bounding box, wherein generating the redaction element in the output format comprises generating a redaction element for each selected text fragment based on the start character and the end character of the associated bounding box.

6. The method of claim 1, further comprising providing a selection of redaction types, the selection including at least one of: a solid redaction type and a translucent redaction type.

7. The method of claim 1, further comprising receiving a reason associated with the redaction and embedding the reason into the output format.

8. The method of claim 1, wherein the output format is a PDF file and the text fragment includes the sensitive information.

9. The method of any of claims 1, wherein the redaction is applied in response to user selection of the text fragment through one of the following user interface actions:
highlighting the text fragment;
right-clicking the text fragment and selecting a redaction option from a context menu;
applying a keyboard shortcut associated with a redaction type.

10. A system for redacting sensitive information within a spreadsheet document, comprising:
one or more processors;
non-transitory computer-readable storage; and
computer-executable instructions stored on the non-transitory computer-readable storage, that when executed by the one or more processors, cause the system to:
receive a spreadsheet document containing a plurality of cells;
provide a user interface for selecting a text fragment within a cell of the spreadsheet document;
apply a redaction to the selected text fragment while maintaining non-redacted content within the same cell; and
convert the spreadsheet document into an output format, the output format incorporating the redaction in such a way that the redaction is non-reversible.

11. The system of claim 10, wherein the instructions further cause the system to provide a translucent redaction overlay, enabling visibility of the redacted text fragment while indicating presence of redaction.

12. The system of claim 11, wherein the instructions further cause the system to replace the selected text fragment with delimiters and to process the delimiters during output file generation to guide application of the redaction.

13. The system of claims 12, further comprising a component that allows the user to select between a solid redaction type and a translucent redaction type.

14. The system of claims 13, wherein the instructions further cause the system to receive and store a redaction reason indicated by the user, the reason being associated with the embedded redaction in the output file.

15. The system of claim 11, wherein the instructions further cause the system to:
define a bounding box associated with the selected text fragment, the bounding box including a start character of the bounding box and an end character of the bounding box; and
process the bounding box when generating the output format including generating a redaction element in the output format based on the start character and the end character.

16. The system of claim 15, wherein the selected text fragment is a plurality of selected text fragments each having an associated bounding box, wherein the instructions further cause the system to generate a redaction element for each selected text fragment based on the start character and the end character of the associated bounding box.

17. A computer-implemented method for redacting text in a document to generate a redacted PDF, the method comprising:
opening a document in a processing environment, wherein the document includes a plurality of text fragments;
executing a search operation within the document using a regular expression to locate text fragments bounded by delimiters, wherein the delimiters indicate portions of text within the document to be redacted;
for each located text fragment, applying a redaction that includes:
setting a foreground color of text in the text fragment to a first color if a translucent redaction is specified, or to a second color if a solid redaction is specified; and
setting a background color of the text fragment to a third color if a translucent redaction is specified, or to a fourth color if a solid redaction is specified;
removing the delimiters from the text fragments within the document;
saving the document as a redacted PDF file in a non-editable format wherein the redacted text fragments are obscured according to the specified redaction type.

18. The method of claim 17, wherein the regular expression used for the search operation includes markers that define a start and end of text fragments to be redacted, with these markers further comprising metadata that assists in a precise location and redaction application during conversion of the document to a PDF.

19. The method of claim 17, further comprising the step of receiving input from a user to select the redaction type from a range of available options, where a choice of redaction type influences foreground and background colors applied to the text fragments.

20. The method of claim 17, wherein a user interface is provided, allowing a reviewer to interact with and alter the redactions applied within the document, and subsequent to such interaction, the method includes the step of updating the document to revise the delimiters and associated metadata to mirror changes made by the reviewer.
